(19) United States
(12) Patent Application Publication
(10) Pub. No.: US 2025/0170013 A1
(43) Pub. Date: May 29, 2025

(54) TWO-DEVICE STIMULATION SYSTEM AND METHODS OF ACTUATING A TWO-DEVICE STIMULATION SYSTEM

(71) Applicant: Kiiroo BV, Amsterdam (NL)

(72) Inventors: Toon Timmermans, Amsterdam (NL); Wilmer Montiel, Amsterdam (NL); Caspar Cnubben, Amsterdam (NL)

(21) Appl. No.: 18/520,006

(22) Filed: Nov. 27, 2023

(51) Int. Cl. A61H 19/00

(52) U.S. Cl. CPC A61H 19/30; A61H 2201/5007; A61H 2201/503; A61H 2201/5058; A61H 2201/5097

(57) ABSTRACT

A two-device sexual stimulation device includes a first device configured to be worn or held by a first individual and a second device configured to be worn or held by a second individual. A sensor in one of the first and second devices generates a signal indicative of how proximity between the first and second devices changes over time or based on relative motion between the first and second devices. A controller on one or both of the devices controls a sexual stimulation device on one or both of the devices based on the signal output by the sensor.

### BACKGROUND OF THE INVENTION

The invention is related to electrically actuated sexual stimulation devices. Many electrically actuated sexual stimulation devices such as vibrators can be controlled to provide varying amounts or modes of stimulation. In the case of a vibrator, this can include selectively varying a frequency of vibration and/or an amplitude or strength of vibration. If a sexual stimulation device includes movable elements that are designed to move or to trace out selected patterns of movement, a controller or the device could selectively vary the pattern of movement and/or the speed of such movements.

In many cases, a user interface on a sexual stimulation device is used to control the operational mode of the device. The user interface can include buttons and other actuator elements as well as indicator lights. Such a user interface can even include a basic display screen.

Some controllable sexual stimulation devices further include a wireless receiver or transceiver, which makes it possible to control the operational mode of the device remotely. The wireless receiver or transceiver could use any standard wireless communications protocols, such as the Bluetooth protocol. Alternatively, the sexual stimulation device could include a WiFi transceiver, making it possible to control the sexual stimulation device from a computer, a smartphone or some other WiFi enabled device. Further, some wireless controllable sexual stimulation devices include a dedicated wireless remote control that itself includes a user interface that makes it possible to remotely control the sexual stimulation device.

When a sexual stimulation device includes wireless control capabilities, a first person can wear or use the sexual stimulation device while a second person controls the operational mode of the sexual stimulation device. Also, a computer can send control signals to the sexual stimulation device based on a predetermined operational control program. Such a control program could be created by the user, or the control program could be acquired from a third party. In some instances, the control program that is used to control a sexual stimulation device may be synchronized in some fashion to a video that the user is watching such that the operational mode of the sexual stimulation device is selectively varied in synchronism with the action occurring in a video.

### BRIEF DESCRIPTION OF THE DRAWINGS

FIGS. 1A-1H are a variety of views of a sexual stimulation device that is configured to be worn by an individual;

FIGS. 2A-2C are diagrams that illustrate selected elements that can be provided in an embodiment of a sexual stimulation device as depicted in FIGS. 1A-1H;

FIG. 3 illustrates how a sexual stimulation device as illustrated in FIGS. 1A-1H can be attached to an adhesive mount that is configured to attach the sexual stimulation device to an individual's body;

FIGS. 4A-4D are diagrams that provide a variety of views of a sexual stimulation device as illustrated in FIGS. 1A-1H attached to an adhesive mount;

FIGS. 5A and 5B illustrate how a sexual stimulation device as illustrated in FIGS. 1A-1H can be attached to a harness that is configured to be worn by an individual;

FIGS. 6A-6E are diagrams that illustrate an actuator device that is configured to be worn or held by an individual and which is part of a two-device sexual stimulation system;

FIGS. 7A-7C illustrate how first and second devices worn or held by first and second individuals can be moved closer together and further apart;

FIG. 8 is diagram illustrating a signal generated by a proximity sensor of one of the first and second devices illustrated in FIGS. 7A-7C, the signal being indicative of how proximity between the first and second devices changes over time, or how one device moves relative to the other over time;

FIG. 9 is a diagram illustrating a signal generated by a proximity sensor of one of the first and second devices illustrated in FIGS. 7A-7C;

FIG. 10 is a diagram illustrating selected elements of a first embodiment of a first device which is part of a two-device sexual stimulation system;

FIG. 11 is a diagram illustrating selected elements of an embodiment of a second device which is part of a two-device sexual stimulation system;

FIG. 12 is a diagram illustrating selected elements of another embodiment of a first device of a two-device sexual stimulation system; and

FIG. 13 is a diagram illustrating selected elements of a computer system which can be incorporated into one or both devices of a two-device sexual stimulation system.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

The present application discloses a two-device sexual stimulation system. A first device is configured to be worn or held by a first individual and a second device is configured to be worn or held by a second individual. At least one of the devices includes a proximity or motion sensor that is able to sense proximity between the two devices and/or relative motion between the two devices. If the sensor is able to detect proximity between the two devices over time, relative motion between the two devices can be calculated by a processor based on the sensed relative proximity.

A sexual stimulation device on one or both of the first and second devices is then driven based on the signal generated by the sensor. As a result, the sexual stimulation device varies its actuation or operation based on changes in proximity between the first and second devices and/or based on the motion of one device relative to the other device.

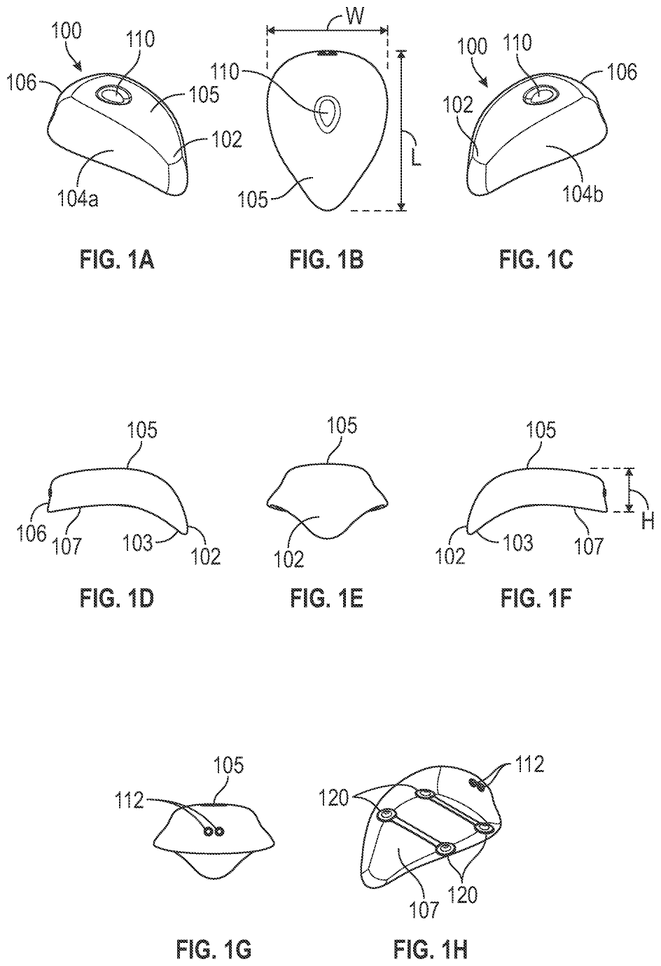

FIGS. 1A-1H illustrate a female sexual stimulation device 100 that can be part of the two-device sexual stimulation system. The female sexual stimulation device 100 is configured to be worn by or attached to a first individual and to provide sexual stimulation to the individual.

The female sexual stimulation device 100 includes first and second sides 104a, 104b, a top surface 105, a bottom surface 107, a rear surface 106 and a front tip 102. As will be explained in greater detail below, various electronic modules are mounted inside a housing of the female stimulation device 100. Those electronic modules can include various different types of sexual stimulation devices.

In the embodiment illustrated in FIGS. 1A-1H, the female sexual stimulation device 100 includes a vibratory module that can be selectively actuated to sexual stimulate an individual wearing the device. The configuration of the female sexual stimulation device 100 is such that the underside 103 of the front tip 102 of the housing can be brought adjacent to or into contact with a woman's clitoris. Thus, vibration of the tip 102 can directly or indirectly stimulate the clitoris.

The embodiment illustrated in FIGS. 1A-1H includes two actuator buttons 112 on the rear surface 106 of the housing that can be used to turn the device on and off, and to control operations of the device 100. A depressed area 110 on the top surface 105 of the housing can also be depressed to operate an actuator switch located on the top of an electronics module mounted inside the housing.

The housing itself can be formed of any suitable plastic or synthetic material, as is well known to those of skill in the art. If indicator lights are located on an electronics module mounted inside the housing, portions of the housing can be sufficiently transparent or translucent such that illumination of the indicator lights can be seen from outside the housing.

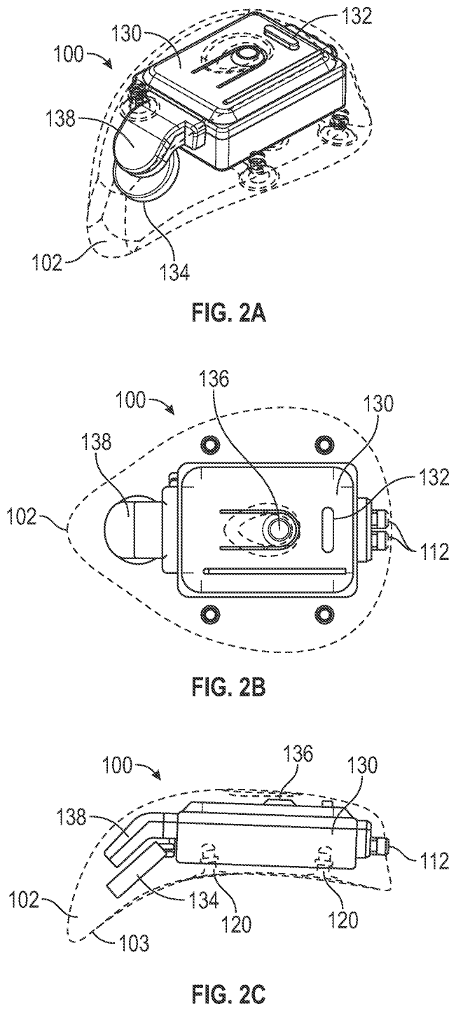

FIGS. 2A-2C illustrate how various elements can be mounted inside the housing of the female sexual stimulation device 100. In this embodiment, an electronics module 130 is mounted inside the housing of the device 100. The electronics module 130 can include a power supply in the form of one or more batteries, one or more processors and associated memory modules, a wireless communications module and one or more proximity or motion sensors. Aspects of these elements are discussed in greater detail below.

As depicted in FIGS. 2B and 2C, an actuator switch 136 is mounted on the top of the electronics module 130. This actuator switch 136 can be operated by pressing on the central depression 110 on the housing, as depicted in FIGS. 1A-1H.

Mounting sockets 120 are provided on the bottom of the housing, and the mounting sockets 120 are used to secure the female sexual stimulation device 100 to an adhesive mount, as described in greater detail below. This allows the female sexual stimulation device to be worn by an individual.

In this embodiment, two actuator switches 112 that are mounted on the electronics module 130 extend to the exterior of the housing of the female sexual stimulation device. Also, one or more indicator lights 132 can be provided on the top of the electronics module 130. The housing of the female sexual stimulation device 100 is sufficiently transparent or translucent in the area directly over the indicator lights 132 that illumination of the indicator lights 132 will be visible to the user.

This embodiment of the female sexual stimulation device 100 includes a vibrator module 134 mounted adjacent the tip 102 of the housing. As will be explained in greater detail below, the vibrator module 134 is actuated based on signals provided one or more by elements of the electronics module 130.

Although this embodiment of the female sexual stimulation device includes a vibrator module 134, other embodiment could have an alternate sexual stimulation device, such as a suction module, moving or rotating fingers or beads or a variety of other devices capable of providing sexual stimulation. Also, one embodiment of the female sexual stimulation device 100 could include multiple different types of sexual stimulation devices. This could include two or more of the same type of sexual stimulation device, or multiple different types of sexual stimulation devices. Thus, the depiction of a single vibration module in the depicted embodiment should in no way be considered limiting.

A sensor 138 mounted adjacent the tip 102 of the housing is configured to sense proximity to a second device, or relative motion between the female sexual stimulation device and a second device, as will be described in greater detail below. The sensor 138 could be a Hall sensor or some other similar type of device which is capable of sensing the strength of a magnetic field and movement of the magnetic field relative to the sensor 138. Of course, the sensor 138 could also be any other type of sensing device which is capable of sensing proximity to a second device, or relative motion between the female sexual stimulation device 100 and a second device.

If the sensor 138 is a Hall effect sensor that is capable of sensing the strength of a magnetic field, the sensor 138 will output a signal having an amplitude that varies depending on the strength of the magnetic field it senses. This means that a simple magnet can be mounted on a second device that is worn by or held by a second individual. As the second individual brings the second device and the associated magnet closer to the sensor 138, the amplitude of the signal output by the sensor 138 will increase. As the second individual moves the second device and the associated magnet away from the sensor 138, the amplitude of signal output by the sensor 138 will decrease. In this way, it is possible to detect how close the second device is to the sensor 138.

Also, if the amplitude of the sensor signal is increasing over time, this means the second device is being brought closer to the sensor 138. Conversely, if the amplitude of the sensor signal is decreasing over time, this means the second device is moving away from the sensor 138. The rate at which the amplitude changes provide an indication of the speed of movement and/or acceleration of the second device relative to the sensor 138. Thus, analysis of the sensor signal can provide multiple different items of information relating to the movement of the second device relative to the female sexual stimulation device 100.

A female sexual stimulation device 100 is designed to be worn by, held by and/or temporarily secured to an individual's body. The way in which the device 100 is secured to the individual can vary. Indeed, the way in which the device 100 is configured and the types of sexual stimulation devices that are incorporated into the female sexual stimulation device 100 may dictate, to some extent, how the device 100 is secured to an individual. Some examples are discussed below.

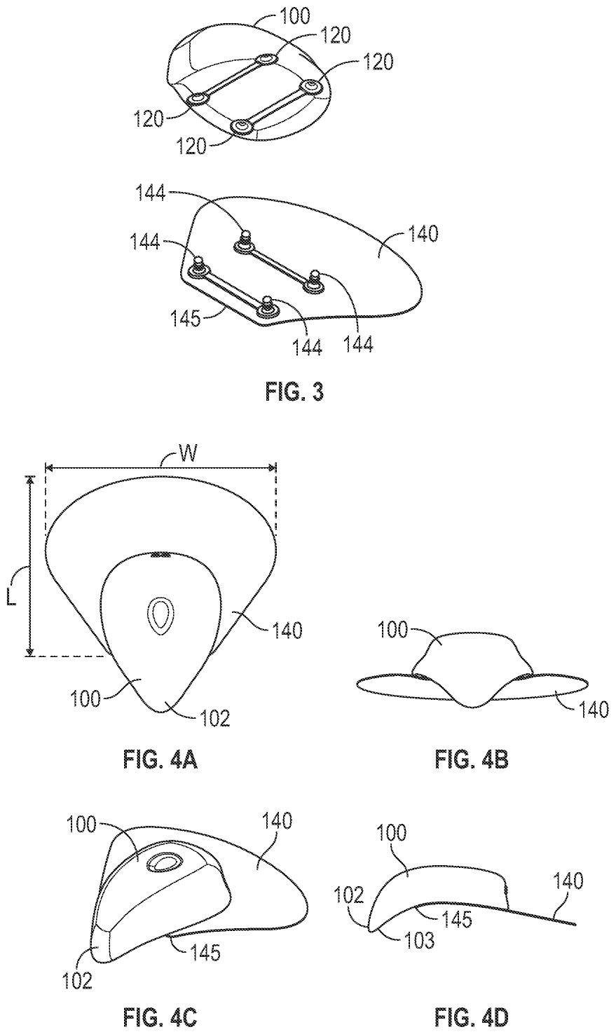

FIG. 3 depicts an adhesive mount 140 that can be used to secure a female sexual stimulation device 100 to an individual. The adhesive mount includes a base having a shape designed to comfortably adhere to a specific part of an individual's anatomy. The bottom of the base has an adhesive layer which may initially be covered with a release layer. To use the adhesive mount, one would peel off the release layer and then adhere the adhesive mount to a specific portion of the individual's skin.

In this embodiment, the adhesive mount includes four mounting posts 144 that extend upward from the adhesive layer. The four mounting posts 144 have a pattern that matches the pattern of four corresponding mounting sockets 120 that are provided on the bottom surface of the female sexual stimulation device 100. Once the adhesive mount has been adhered to the individual, the female sexual stimulation device 100 is lowered down onto the mount so that the mounting posts 144 are received in the mounting sockets 120.

Each of the mounting posts 144 has a profile that includes a rounded knob at the top, and a reduced diameter portion under each rounded knob. The mounting sockets 120 on the female sexual stimulation device 100 includes a reduced diameter portion that is configured to register with the reduced diameter portion of the mounting posts 144. Thus, as the mounting posts 144 are inserted into the mounting sockets 120, the knob at the end of each mounting post 144 passes the reduced diameter portion of the mounting socket 120. The reduced diameter portion of the mounting sockets 120 then rests in the reduced diameter portion of the mounting post 144 to hold the female sexual stimulation device 100 on the adhesive mount 140, and thus to the individual to which the adhesive mount 140 is attached. To remove the female sexual stimulation device 100, one need only apply sufficient upward force to cause the knobs at the ends of the mounting posts 144 to pass the reduced diameter portions of the mounting socket 120.

FIGS. 4A-4D provide various depictions of a female sexual stimulation device 100 secured to the top of an adhesive mount 140. The adhesive mount 140 has a width W and a length L. The dimensions of the adhesive mount 140 and the female sexual stimulation device can vary. As depicted in FIGS. 3, 4C and 4D, a front edge 145 of the adhesive mount 140 ends well before the tip 120 of the female sexual stimulation device 100. This allows the underside 103 of the tip 102 of the female sexual stimulation device 100 to directly contact an underlying part of the individual's skin or anatomy to provide vibratory sexual stimulation. Alternatively, if some other type of sexual stimulation device were mounted in the female sexual stimulation device 100, that alternate stimulation device would also be able to directly contact the skin or an underlying part of the individual's anatomy.

FIGS. 2A-4D depict an embodiment where a vibration module 134 is provided on the tip 102 of the female sexual stimulation device 100. For that reason, the adhesive mount 140 used to secure the female sexual stimulation device 100 to an individual's body is configured so that the tip 102 can contact the individual's skin. If a sexual stimulation device were provided on a different location on the female sexual stimulation device 100, the adhesive mount 140 could be configured differently so that that alternate stimulation device could contact the individual's skin. For example, if a suction device or moving elements were provided in the middle of the underside of the electronics module 130, a corresponding cutout could be provided in the center portion of the adhesive mount so that the suction device or moving elements could directly contact an underlying part of the individual's anatomy.

To ensure that the female sexual stimulation device is properly positioned on an individual to stimulate the proper part of the individual's anatomy, the female sexual stimulation device 100 may be first mounted to the adhesive mount 140 by inserting the mounting posts 144 into the mounting sockets 120 on the female sexual stimulation device. The release layer covering the adhesive layer on the adhesive mount 140 could then be removed from the adhesive mount 140, and the combination of the female sexual stimulation device 100 and the adhesive mount 140 could be positioned properly and then brought into contact with the individual's skin to secure the assembly to the individual.

Also, the adhesive mount 140 and/or the female sexual stimulation device 100 may include an adjustment mechanism which allows the position of the female sexual stimulation device 100 to be adjusted relative to the adhesive mount 140, and therefore relative to the anatomy of the individual to which the adhesive mount 140 is attached.

U.S. patent application Ser. No. 18/388,346 discloses various different embodiments of an adhesive mount which could be used in connection with the female sexual stimulation device. The disclosure of U.S. patent application Ser. No. 18/388,346 is incorporated herein by reference.

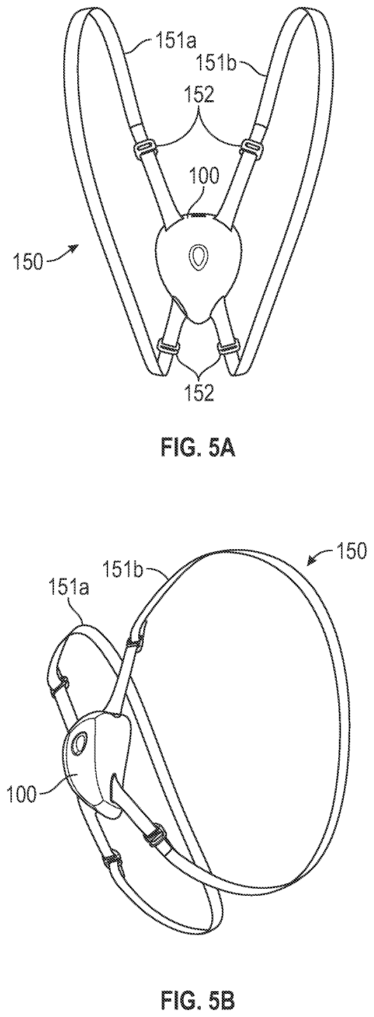

FIGS. 5A and 5B illustrate an alternate way of mounting a female sexual stimulation device 100 to an individual. In this embodiment, a harness 150 is attached to the female sexual stimulation device 100. In this instance, the female sexual stimulation device 100 itself could include attachment points to mount the harness 150. Alternately, a pocket that is configured to hold and closely match the shape of the female sexual stimulation device 100 could be a part of the harness 150.

The harness 150 includes first and second straps 151a, 151b which are designed to surround an individual's legs or thighs. Adjustment mechanisms 152 can be provided on the first and second straps 151a, 151b so that the straps can be tightened around the individual's legs or thighs to secure the female sexual stimulation device 100 to the individual. The adjustment mechanisms could also be used to adjust the position of the female sexual stimulation device 100 relative to the anatomy of the individual so that the female sexual stimulation device 100 can be brought adjacent to or in contact with a desired part of the individual's anatomy.

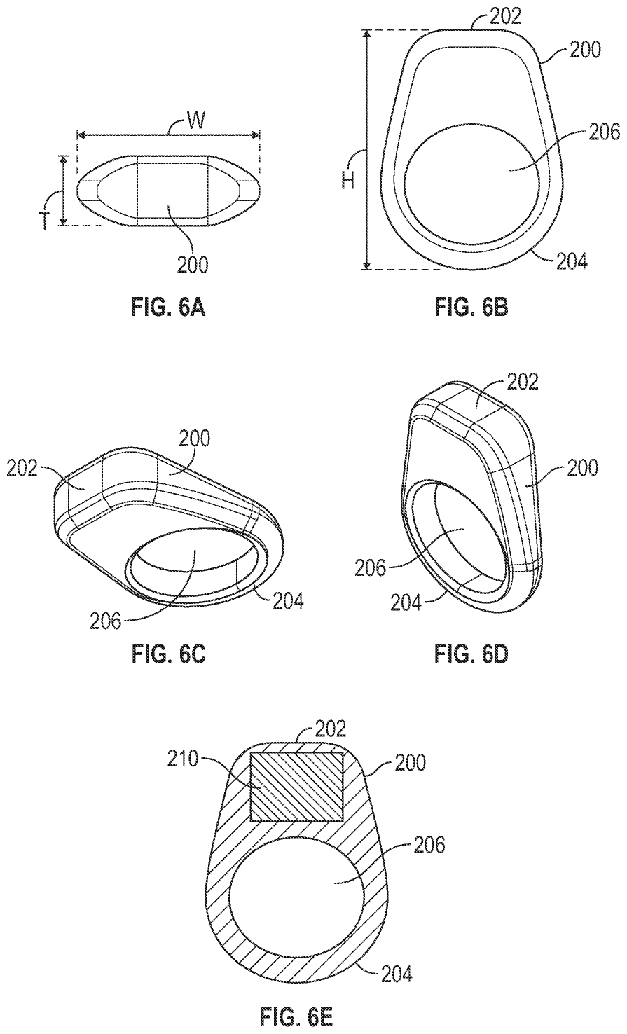

FIGS. 6A-6E illustrate a second device 200, which for purposes of the following discussion we will call a “male device.” The male device 200 is to be used in conjunction with the female sexual stimulation device 100 described above. Together, the female sexual stimulation 100 and the male device 200 comprise a two-device stimulation system.

The male device 200 has a flexible body or housing that includes a top 202 and a bottom 204. A mounting aperture 206, which in this instance is a circular hole, is provided on the body of the male device 200. As depicted in FIGS. 6E, a magnetic element 210 is mounted inside the top 202 of the housing.

The body or housing of the made device has a height H, a width W and a thickness T. The overall size of the male device 200 and the size of the mounting aperture 206 allow the male device to be mounted on a man's penis. Alternatively, the male device could be mounted on a finger of an individual's hand. The material of the male device 200 is soft and flexible so that the male device can accommodate different sized body parts. Also, the male device could come in various sizes and configurations, some designed to be mounted on a man's penis and others designed to be worn on a finger, thumb or other body part.

The basic concept is for a female sexual stimulation device 100 to be mounted on or secured to a first individual and for a male device 200 to be mounted on or secured to a second individual. Once mounted, movement of the male device 200 relative to and in proximity to the female sexual stimulation device 100 will be sensed be the sensor 138 in the female sexual stimulation device 100. A signal generated by the sensor 138 is then used to drive the vibrator module 134 in the female sexual stimulation device 100. The operation of the vibrator module 134 can be selectively varied depending on sensed movement of the male device 200 relative to the female sexual stimulation device 100.

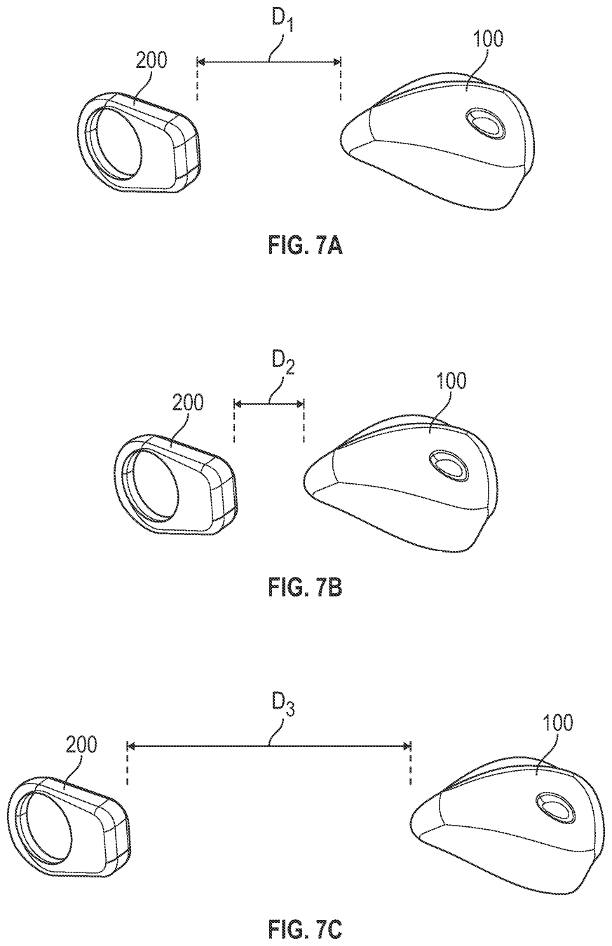

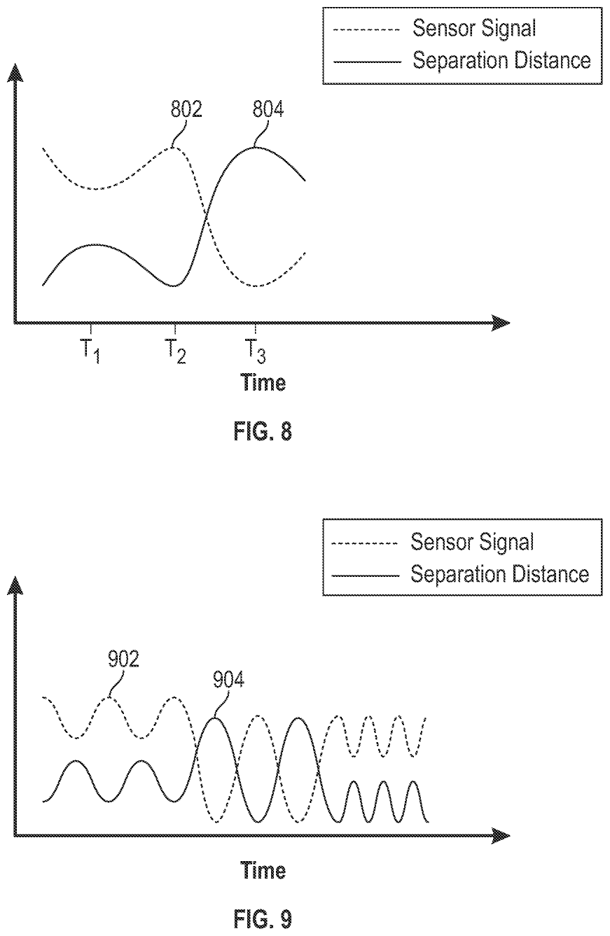

FIGS. 7A-7C and 8 help to explain this operational principle. FIG. 7A shows a male device 200 located a distance D1 from a female sexual stimulation device 100 at time T1. The male device 200 then moves closer to the female sexual stimulation device 100 so that they are separated by a distance D2 at time T2. Thereafter, the male device 200 is moved away from the female sexual stimulation device 100 so that it assume a separate distance D3 at time T3.

As this motion is occurring, the sensor 138 in the female sexual stimulation device 100 will be sensing the magnetic field provided by the magnetic element 210 inside the male device 200. The sensor 138 will output a signal that increases in amplitude between time T1 and time T2 because the magnetic element 210 was brought closer to the sensor 138 between time T1 and T2. The sensor 138 will output a signal that decreases in amplitude between time T2 and time T3 because the magnetic element 210 was spaced further apart from the sensor 138 between time T2 and T3.

FIG. 8 provides a graphical illustration of the amplitude of the sensor signal 802, which appears as a dashed line in FIG. 8. FIG. 8 also illustrates the separation distance 804 between the male device 200 and the female sexual stimulation device 100, which appears as a solid line in FIG. 8. Both the amplitude of the sensor signal 802 and the separation distance 804 vary as the movements depicted in FIGS. 7A-7C occur. Note, the waveform of the separation distance 804 is essentially the inverse of the amplitude of the signal 802 output by the sensor 138 in the female sexual stimulation device 100 because increasing amplitude means decreasing separation distance.

FIG. 9 provides another depiction similar to the one provided in FIG. 8, but covering a much longer period of time. The dashed waveform 902 represents the amplitude of the signal output by the sensor 138 of the female sexual stimulation device 100. The solid waveform 904 represents how the separation distance between the male device 200 and the female sexual stimulation device vary over time.

The electronics module 130 of the female sexual stimulation device 100 could use either or both of the waveforms 902, 904 illustrated in FIG. 9 to control the operation of the vibration module 134. Also, a processor of the electronics module 130 could use the sensor signal 902 to calculate the speed of movement of the male device 200 relative to the female sexual stimulation device 100, or the rate at which the speed changes, which is acceleration. The calculated speed or acceleration could then be used to control operation of the vibration module 134, either alone or in combination with the sensor signal and/or the waveform representing the separation distance.

In the foregoing description, we have referred to the device depicted in FIGS. 1A-1H as the “female” device. Likewise, we have referred to the device depicted in FIGS. 6A-6E as the “male” device. This convention was simply for the sake of convenience. In fact, either device could be mounted to or worn by a man or mounted to and worn by a woman. For that reason, going forward we will make references to a “first” device and a “second” device. The “first” device would generally correspond to the one shown in FIGS. 6A-6E. The “second” device would generally correspond to the one illustrated in FIGS. 1A-1H. Together, a first device and a second device would form a two-device stimulation system.

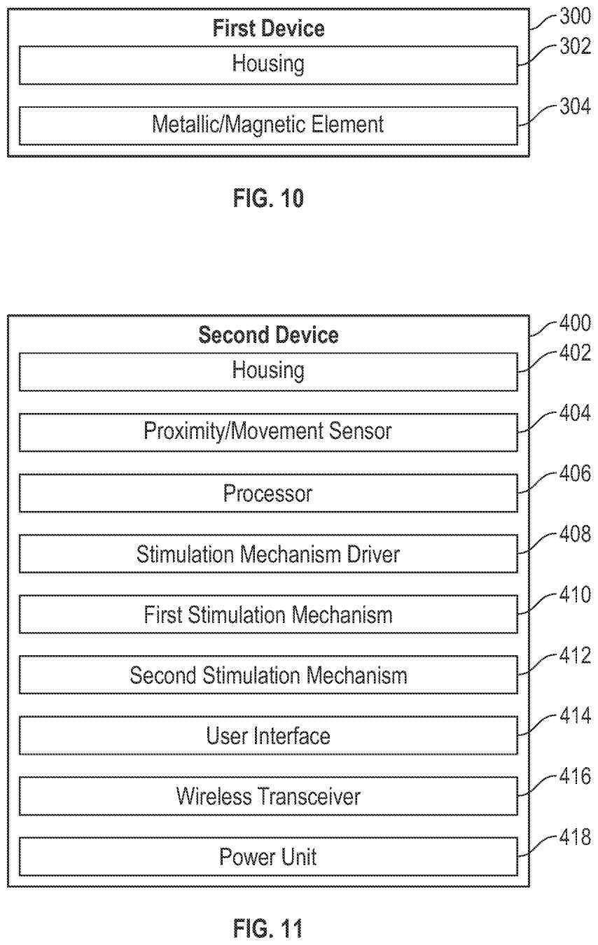

FIG. 10 is a block diagram that illustrates the key elements of a first device 300. As shown therein, the first device 300 includes a housing 302 and a metallic/magnetic element 304 mounted in or on the housing 302.

The housing 302 could take on virtually any form that allows the first device 300 to be mounted on, affixed to, held by or worn by an individual. This could be a shape similar to the one illustrated in FIGS. 6A-6E, which allow the first device 300 to be mounted on a man's penis or an individual's finger. However, the housing 302 could have a variety of other shapes which enable the first device 300 to be mounted to other parts of an individual or an individual's anatomy. Also, the first device 300 could be attached to an individual using a separate mounting mechanism, such as an adhesive mount or a mounting harness.

The first device 300 also includes a metallic/magnetic element 304 which is what a second device will sense to determine position or movement of the first device 300 relative to the second device. The type of metallic/magnetic element that is provided may depend on the type of sensor that is present in the second device to sense position or movement of the first device 300 relative to the second device. The foregoing description indicates that a sensor in the second device could be configured to sense a magnetic field that is provided by a magnetic element 304 on the first device 300. However, alternate sensors could be configured to detect the metallic/magnetic element 304 in different ways. Thus, the type of sensor and the type of element provided in the first device 300 should in no way be limited by the foregoing examples.

FIG. 11 illustrates selected elements of a second device 400. The second device also includes a housing 402. Similar to the housing 302 of the first device 300, the housing 402 of the second device 400 could take on virtually any form that allows the second device 400 to be mounted on, affixed to, held by or worn by an individual. This could be a shape similar to the one illustrated in FIGS. 1A-1H, which allow the second device 400 to be mounted on a female adjacent the clitoris. However, the housing 402 could have a variety of other shapes which enable the second device 400 to be mounted to other parts of an individual or an individual's anatomy. Also, the second device 400 could be attached to an individual using a separate mounting mechanism, such as an adhesive mount or a mounting harness.

The second device 400 also includes a proximity/movement sensor 404. In the descriptions provided above, a Hall type sensor is used to sense a magnetic field provided by a magnetic element on the first device 300. However, in alternate embodiments the sensor 404 could employ various other sensing techniques or sensing technologies. All that really matters is that the sensor 404 be capable of detecting relative position or relative movement between the second device 400 and the first device 300. Also, some embodiments of the second device 400 may employ multiple sensors 404. When multiple sensors are provided, they could be multiple ones of the same type of sensor, or multiple different types of sensors.

The second device 400 further includes one or more processors 406 that receive one or more signals from the sensor or sensors 404. In some embodiments, the processor 406 may itself use the signals from the sensor or sensors 404 to directly generate a drive signal that is used to drive a sexual stimulation device. On other embodiments, the one or more processors 406 may receive the signal(s) from the sensor(s) 404 and process the signal(s) to determine things like relative positions between the first 300 and second 400 devices, and/or relative movements and accelerations of the first device 300 relative to the second device 400. This information, as well as the signal(s) from the sensor(s) 404 could then be passed to a stimulation mechanism driver 408, which is an optional feature.

When provided, the stimulation mechanism driver 408 uses signals such as the signal(s) from the sensor(s) 404, as well as processed signals generated by the one or more processors 406 to generate one or more drive signals that cause actuation of one or more stimulation mechanisms.

The second device 400 also includes at least a first stimulation mechanism 410 configured to sexually stimulate an individual. The stimulation mechanism 410 could be vibratory module, a suction module, one or more movable actuators, rotating beads or a variety of other stimulation devices. The first stimulation mechanism 410 is capable of selectively varying its operational state based on a drive signal provided by the one or more processors 406 or the stimulation mechanism driver 408.

In some embodiments, the second device 400 could further include a second stimulation mechanism 412, although this is an optional feature. When provided, the second stimulation mechanism 412 could be the same type of stimulation mechanism as the first stimulation mechanism 410, or the second stimulation mechanism 412 could be of a different type. Regardless, the second stimulation mechanism 412 may or may not also be capable of selectively varying its operational state in response to a drive signal provided by the one or more processors 406 or the stimulation mechanism driver 408.

The second device 400 further includes a user interface 414. The user interface 414 could take a variety of different forms. In some embodiments, the user interface 414 could include buttons or switches on the housing 402 of the second device 400. The user interface 414 could further include one or more lighting devices that illuminate to communicate information to a user.

The second device 400 could also include a wireless transceiver 416 that is configured to communicate using a wireless radio signal. The wireless transceiver 416 could be a Bluetooth module or a WiFi module configured to communicate over a standard WiFi computer network. When the second device includes a wireless transceiver 416, the user interface 414 could be partially or fully provided via a software application that runs on a smartphone, a laptop or tablet computer or a desktop computer. The wireless transceiver 416 would allow the user to configure the second device 400 and to control the second device 400 via the software application running on a separate computing device.

When a software application running on a separate computing device is able to communicate with the second device 400 via the wireless transceiver 416, the software application could send control signals to the second device 400 that are used to drive the first stimulation mechanism 410 and/or the second stimulation mechanism 412. Also, the processor 406 could send signals to the software application that are based on the signal(s) received from the sensor(s) 404, and the software application could use that information to generate drive signals that are communicated to the second device 400 and that are used to drive the first stimulation mechanism 410 and/or the second stimulation mechanism 412.

Finally, the second device 400 includes a power unit 418, which would typically be a battery. The power unit 418 could be a replaceable battery or a rechargeable battery. If the battery is rechargeable, the charge could be obtained via a wired connection or via an inductive coupling.

The elements of the second device 400 depicted in FIG. 11 and described above represent but one way of configuring a second device. In alternate embodiments, the second device 400 could include fewer than all the elements depicted in FIG. 11 or additional elements that are not depicted in FIG. 11. Thus, the depiction in FIG. 11 and the description provided above should in no way be considered limiting.

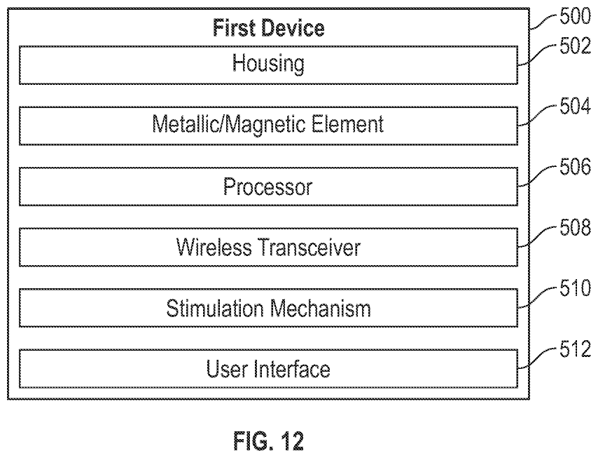

In the embodiments discussed above, the first device 300 was relatively simple and included only a housing 302 and a metallic/magnetic element 304 that could be sensed by the second device 400. However, in alternate embodiments the first device could include significant additional capabilities. FIG. 12 depicts an alternate embodiment of a second device 500 which includes many elements in addition to those depicted in FIG. 10.

The first device 500 depicted in FIG. 12 still includes a housing 502 and a metallic/magnetic element 504. As a result, it will still be possible for a second device 400 with a proximity/movement sensor(s) 404 to detect the position and/or motion the first device 500 relative to the second device 400.

The first device 500 also includes one or more processors 506 and a wireless transceiver 508. The first device further includes a stimulation mechanism 510 and a user interface 512. These elements of the first device 500 can be the same as or similar to the corresponding elements of the second device 400 described above.

When a first device 500 is equipped with the elements depicted in FIG. 12, the first device 500 can also deliver sexual stimulation to the individual to which it is attached via the stimulation mechanism 510. In some embodiments, a drive signal that is generated by a processor 406 or a stimulation mechanism driver 408 of the second device 400 could be communicated to the first device 500 using the wireless transceivers 416/508 of the two devices. This makes it possible for the stimulation mechanism 510 to be driven in a way similar to how the first and/or second stimulation mechanism 410/412 of the second device 400 is driven.

Alternatively, the processor 406 and/or stimulation mechanism driver 408 of the first device 400 could use signals from the sensor(s) 404 of the first device 400 and/or processed signals provided by the processor 406 to generate one or more completely separate drive signals that are tailored for the first device 500. The separate drive signal could then be sent to the first device 500 via the wireless transceivers 416/508 of the two devices, and used to drive the operation of the stimulation mechanism 510 of the first device 500

In still other embodiments, the signals from the sensor(s) 404 of the second device 400 and well as processed signals generated by the processor 406 of the second device 400 could be communicated to the processor 506 of the first device 500 via the wireless transceivers 416/508, and the processor 506 of the first device 500 could use those signals to generate a drive signal that drives the stimulation mechanism 540 of the first device 500.

In all of the embodiments described above, the drive signals that are used to drive operation of a stimulation mechanism can drive the stimulation mechanism in a variety of different ways. The operation of a stimulation mechanism could be selectively varied based on a sensed proximity of the first device to the second device. The way in which the operation of the stimulation mechanism is selectively varied will depend, in part, on how the stimulation device operates.

For example, if the stimulation mechanism is a vibratory module, a frequency of the vibration could be selective varied. For example, the frequency of vibration could be increased as the first device get closer to the second device, while the amplitude of vibrations is held the same. Likewise, the frequency of the vibrations could be decreased as the first device is moved away from the second device, while the amplitude of the vibrations is held the same. Or vice versa.

Similarly, an amplitude of the individual vibrations could be selectively varied while the frequency of vibration is held the same. For example, the amplitude of the vibrations could be increased as the first device is moved closer to the second device, and the amplitude of the vibrations could be decreased as the first device moves away from the second device. Or vice versa.

In other embodiments, the frequency of the vibration and the amplitude of the vibrations could be selectively varied as the first device moves relative to the second device. This could mean increasing the frequency and amplitude of vibrations as the first device moves closer to the second device, and decreasing both the frequency and amplitude of vibrations as the first device moves away from the second device. Or vice versa.

In yet other embodiments, the frequency could be increased while the amplitude decreases as the first device moves closer to the second device. Or the amplitude could be increased while the frequency decreases as the first device moves closer to the second device. Or the inverse of those combinations could occur.

As should be apparent from the foregoing discussion, there are many different ways to selectively vary the vibrations provided by a vibratory module based on the movement or relative positions of a first device relative to a second device. But this is only part of the possibilities.

As mentioned above, the signal output by a position or movement sensor can be processed to calculate the speed of movement of the first device relative to the second device, as well as an acceleration of the first device relative to the second device. The relative position, or the speed of movement or the acceleration could all be used to selectively vary the frequency and/or amplitude of vibrations provided by a vibration module. However, it would also be possible to selectively vary the frequency and/or amplitude of vibrations of a vibration module based on combinations of position, speed of movement and acceleration. Thus, there are a large number of ways of selectively varying the vibrations of a vibration module based on a sensor signal that is merely indicative of relative positions of first and second devices.

The same is also true when the drive signals are used to drive other types of stimulation mechanisms. For example, if the stimulation mechanism is a suction device that provides alternately increasing and decreasing cycles of suction to a particular part of an individual's anatomy, the suction device could be controlled in a way similar to a vibration module. In other words, it may be possible to selectively vary the amplitude amount of suction, and the frequency of the increasing and decreasing cycles of suction. In this case, the same principles discussed above in connection with selectively driving a vibratory module would likewise apply to driving a suction module.

Of course, if the stimulation mechanism is some other type of stimulation mechanism, the way in which the operation of the stimulation mechanism is selectively varied will depend on how the device operates. Still, it will likely be possible to drive the stimulation mechanism in a variety of different ways based on a signal output from a position sensor.

The present invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object-oriented programming language, such as JavaScript, Java®, Swift or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

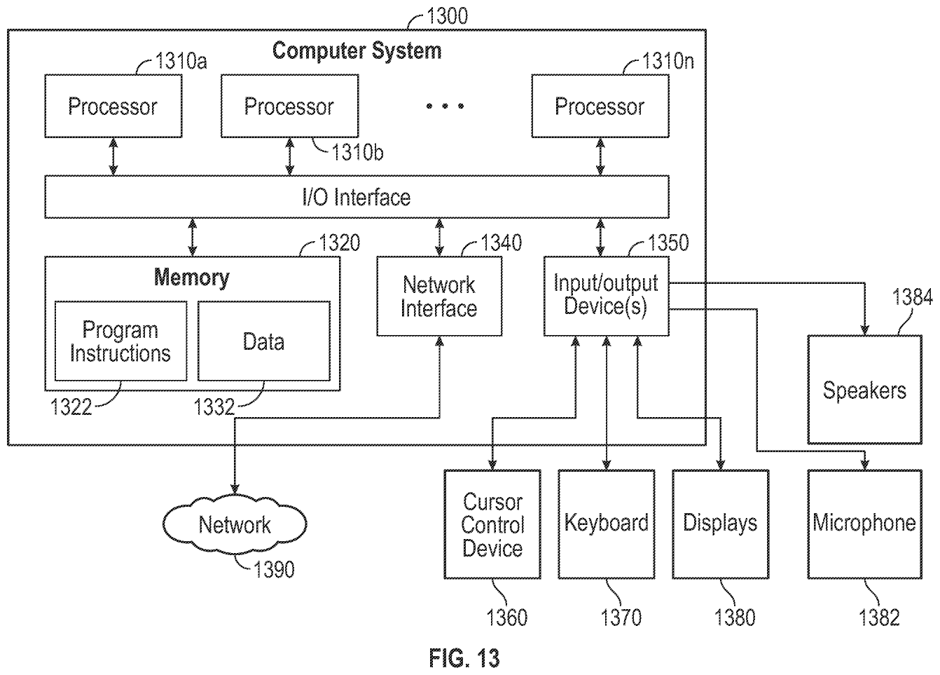

FIG. 13 depicts a computer system 1300 that can be utilized in various embodiments of the present invention to implement the invention according to one or more embodiments. The various embodiments as described herein may be executed on one or more computer systems, which may interact with various other devices. One such computer system is the computer system 1300 illustrated in FIG. 13. The computer system 1300 may be configured to implement the methods described above. The computer system 1300 may be used to implement any other system, device, element, functionality or method of the above-described embodiments. In the illustrated embodiments, the computer system 1300 may be configured to implement the disclosed methods as processor-executable executable program instructions 1322 (e.g., program instructions executable by processor(s) 1310) in various embodiments.

In the illustrated embodiment, computer system 1300 includes one or more processors 1310a-1310n coupled to a system memory 1320 via an input/output (I/O) interface 1330. Computer system 1300 further includes a network interface 1340 coupled to I/O interface 1330, and one or more input/output devices 1350, such as cursor control device 1360, keyboard 1370, display(s) 1380, microphone 1382 and speakers 1384. In various embodiments, any of the components may be utilized by the system to receive user input described above. In various embodiments, a user interface may be generated and displayed on display 1380. In some cases, it is contemplated that embodiments may be implemented using a single instance of computer system 1300, while in other embodiments multiple such systems, or multiple nodes making up computer system 1300, may be configured to host different portions or instances of various embodiments. For example, in one embodiment some elements may be implemented via one or more nodes of computer system 1300 that are distinct from those nodes implementing other elements. In another example, multiple nodes may implement computer system 1300 in a distributed manner.

In different embodiments, the computer system 1300 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 1300 may be a uniprocessor system including one processor 1310, or a multiprocessor system including several processors 1310 (e.g., two, four, eight, or another suitable number). Processors 1310 may be any suitable processor capable of executing instructions. For example, in various embodiments embedded processors processors 1310 may be general-purpose implementing any of a variety of instruction set architectures (ISAs). In multiprocessor systems, each of processors 1310 may commonly, but not necessarily, implement the same ISA.

System memory 1320 may be configured to store program instructions 1322 and/or data 1332 accessible by processor 1310. In various embodiments, system memory 1320 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1320. In other embodiments, program instructions and/or data may be received, sent or stored upon different types of computer-accessible media or on similar media separate from system memory 1320 or computer system 1300.

In one embodiment, I/O interface 1330 may be configured to coordinate I/O traffic between processor 1310, system memory 1320, and any peripheral devices in the device, including network interface 1340 or other peripheral interfaces, such as input/output devices 1350. In some embodiments, I/O interface 1330 may perform any necessary protocol, timing or other data transformations to convert data signals from one component (e.g., system memory 1320) into a format suitable for use by another component (e.g., processor 1310). In some embodiments, I/O interface 1330 may include support for devices attached through various types of peripheral buses, such as a variant of the Peripheral Component Interconnect (PCI) bus standard or the Universal Serial Bus (USB) standard, for example. In some embodiments, the function of I/O interface 1330 may be split into two or more separate components, such as a north bridge and a south bridge, for example. Also, in some embodiments some or all of the functionality of I/O interface 1330, such as an interface to system memory 13020, may be incorporated directly into processor 1310.

Network interface 1340 may be configured to allow data to be exchanged between computer system 1300 and other devices attached to a network (e.g., network 1390), such as one or more external systems or between nodes of computer system 1300. In various embodiments, network 1390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1340 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1350 may, in some embodiments, include one or more display terminals, keyboards, keypads, touchpads, scanning devices, voice or optical recognition devices, or any other devices suitable for entering or accessing data by one or more computer systems 1300. Multiple input/output devices 1350 may be present in computer system 1300 or may be distributed on various nodes of computer system 1300. In some embodiments, similar input/output devices may be separate from computer system 1300 and may interact with one or more nodes of computer system 1300 through a wired or wireless connection, such as over network interface 1340.

In some embodiments, the illustrated computer system may implement any of the operations and methods described above. In other embodiments, different elements and data may be included.

Those skilled in the art will appreciate that the computer system 1300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 1300 may also be connected to other devices that are not illustrated, or instead ay operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1300 may be transmitted to computer system 1300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An apparatus for sexual stimulation, comprising:
a first device that is configured to be held by, worn by or mounted to an individual; and
a second device that is configured to be coupled to an individual, the second device including:
a first sensor that is configured to sense movement of the first device relative to the second device and to generate a first motion signal based on the sensed relative motion, and
a first stimulation mechanism for sexually stimulating the individual to which the second device is coupled, wherein the first stimulation mechanism is configured to operate based, at least in part, on the first motion signal.

2. The apparatus of claim 1, wherein the first device includes a metallic element and the first sensor is configured to sense motion of the metallic element relative to the second device.

3. The apparatus of claim 1, wherein the first device includes a magnet and the first sensor is configured to sense motion of the magnet relative to the second device.

4. The apparatus of claim 1, wherein the first motion signal generated by the first sensor is indicative of a proximity of the first device to the second device.

5. The apparatus of claim 4, wherein the first motion signal generated by the first sensor is also indicative of a speed of movement of the first device relative to the second device.

6. The apparatus of claim 1, wherein an operational state of the first stimulation mechanism is selectively varied based on the first motion signal.

7. The apparatus of claim 1, wherein the second device includes a second stimulation mechanism for sexually stimulating the individual to which the second device is coupled.

8. The apparatus of claim 7, wherein the second stimulation mechanism is configured to operate based, at least in part, on the first motion signal.

9. The apparatus of claim 8, wherein an operational state of the first stimulation mechanism is selectively varied in a first way based on the first motion signal and wherein an operational state of the second stimulation mechanism is varied in a second way based on the first motion signal.

10. The apparatus of claim 9, wherein the first way is the same as the second way.

11. The apparatus of claim 9 wherein the first way is different from the second way.

12. The apparatus of claim 1, wherein the second device further comprises at least one processor that is configured to generate a drive signal based on the first motion signal, wherein the drive signal is used to drive operation of the first stimulation mechanism.

13. The apparatus of claim 12, wherein the at least one processor is configured to generate a speed signal indicative of a speed of movement of the first device relative to the second device based on the first motion signal, and wherein the drive signal generated by the at least one processor is also based on the speed signal.

14. The apparatus of claim 1, wherein the first device includes a second stimulation mechanism configured to sexually stimulate an individual to which the first device is coupled.

15. The apparatus of claim 14, wherein the second stimulation mechanism is configured to operate based, at least in part, on the first motion signal.

16. The apparatus of claim 14, wherein the second device includes a wireless transmitter configured to transmit a second device signal that is based on the first motion signal, wherein the first device comprises a wireless receiver configured to receive the second device signal, and wherein the second stimulation device is configured to operate based, at least in part, on the received second device signal.

17. The apparatus of claim 1, wherein the second device comprises a wireless receiver/transceiver, and wherein the first stimulation mechanism is configured to operate based, at least in part, on a control signal received via the wireless receiver/transceiver.

18. An apparatus for sexual stimulation, comprising:
a housing that is configured to be coupled to an individual;
a sensor mounted on the housing and configured to sense movement of a separate device relative to the sensor, wherein the sensor generates a motion signal based on the sensed relative movement, and
a first stimulation mechanism for sexually stimulating the individual to which the housing is coupled, wherein the first stimulation mechanism is configured to operate based, at least in part, on the motion signal.

19. The apparatus of claim 18, wherein the sensor is configured to sense movement of a metallic or magnetic element on the separate device relative to the sensor.

20. The apparatus of claim 18, wherein an operational state of the first stimulation mechanism is selectively varied based on the motion signal.
